(19) United States
(12) Patent Application Publication
(10) Pub. No.: US 2013/0036866 A1
(43) Pub. Date: Feb. 14, 2013

(54) Cermet and Coated Cermet

(71) Applicants: Keitaro Tamura, Iwaki-shi (JP); Koji Hayashi, Kuki-shi (JP); Kiyoka Taniguchi, Kanagawa (JP)

(72) Inventors: Keitaro Tamura, Iwaki-shi (JP); Yasuro Taniguchi, Yokohama-shi (JP); Koji Hayashi, Kuki-shi (JP)

(73) Assignee: Tungaloy Corporation, Iwaki-shi (JP)

(21) Appl. No.: 13/643,359

(22) PCT Filed: Apr. 26, 2011
(86) PCT No.: PCT/JP2011/060105

§ 371 Date: Oct. 25, 2012

(30) Foreign Application Priority Data
Apr. 26, 2010 (JP) 2010-100524

(51) Int. Cl. B32B 15/02

(52) U.S. Cl. 75/240

(57) ABSTRACT

A cermet has a first hard phase of a complex carbonitride solid solution, a second hard phase of WC, and a binder phase mainly comprising Co and Ni as main component(s). The first hard phase has a core/rim structure. The core is represented by (Ti_{1-x-y}LₓMo_{y})(C_{1-z}N_{z}) and the rim is represented by (Ti_{1-a-b-d}RₐMo_{b}W_{d})(C₁₋ₑNₑ), wherein L and R each represent at least one element selected from the group consisting of Zr, Hf, Nb and Ta. If a maximum thickness of the rim of the core/rim structure grains of the first hard phase is given by rₘₐₓ, and a minimum thickness of the rim of the core/rim structure grains of the first hard phase is given by rₘᵢₙ, a number of the core/rim structure grains of the first hard phase satisfying 0.2<(rₘᵢₙ/rₘₐₓ)<1 is 85% or more, based on the total number of the core/rim structure grains of the first hard phase.

### TECHNICAL FIELD

The present invention relates to a cermet and a coated cermet used for a cutting tool, etc.

### BACKGROUND ART

The conventional Ti(C,N)-based cermet has been produced by sintering mixed powder comprising Ti(C,N) powder which becomes a main starting material, each powder of Co and Ni which becomes a binder phase, and each powder of WC, Mo₂C, NbC and/or TaC for improving sinterability or mechanical characteristics, etc. It has been well known that the obtained Ti(C,N)-based cermet takes the structure comprising the hard phase which comprises grains having a core/rim structure wherein Ti(C,N) is a core, and a carbonitride containing W, Mo, Nb, Ta, etc., is a rim, and the binder phase which comprises Co and Ni wherein Ti, W, Mo, Nb, Ta, etc., are dissolved therein (for example, see Patent literature 1.).

Also, when an added amount of WC or Mo₂C is increased, its alloy structure varies depending on added amounts of NbC, TaC, etc., and exists grains having a core/rim structure comprising Ti(C,N) as a core and a carbonitride containing W, Mo, Nb, Ta, etc., as a rim, Ti(C,N) single grains having no core/rim structure, grains having a core/rim structure comprising a solid solution of Ti(C,N) and an added carbide as a core, WC and/or Mo₂C grains, etc., as a hard phase, and in the grains having a core/rim structure comprising Ti(C,N) as a core and a carbonitride containing W, Mo, Nb, Ta, etc., as a rim, there exist grains in which the core is not covered by the rim, thus, the structure is markedly different from each other depending on the composition (for example, see Patent literature 2.).

Thus, there are problems that the structure of the conventional Ti(C,N)-based cermet shows an ununiform structure, which worsens wear resistance or fracture resistance of the cutting tool, and further makes fluctuation of tool life remarkable.

### PRIOR ART LITERATURES

### Patent Literatures

[Patent literature 1] JP H04-231467A
[Patent literature 2] JP H10-110234A

### SUMMARY OF THE INVENTION

### Problems to be Solved by the Invention

The present invention has been done to solve the above-mentioned problems, and an object thereof is to provide a cermet and a coated cermet in which ununiformity of the hard phase of the cermet is cancelled, they have excellent wear resistance and fracture resistance than those of the conventional ones and have less fluctuation in the tool life, and stable cutting can be carried out.

### Means to Solve the Problems

The present inventors have found that a complex carbonitride solid solution powder in which at least one element selected from the group consisting of Zr, Hf, Nb and Ta, and Mo are dissolved in Ti(C,N) is used as starting powder in place of Ti(C,N) powder which becomes a main starting material of the conventional Ti(C,N)-based cermet, and an added amount of WC is increased until WC grains exist as a hard phase, whereby a cermet could be obtained, in which the hard phase is constituted by core/rim structure grains wherein the core comprises a complex carbonitride solid solution the metal element of which comprises Ti, at least one element (L element) selected from the group consisting of Zr, Hf, Nb and Ta, and Mo, and the rim uniformly surrounding the core comprises a complex carbonitride solid solution the metal element of which comprises Ti, at least one element (R element) selected from the group consisting of Zr, Hf, Nb and Ta, and Mo and W, and grains comprising WC. It was found that ununiformity of the hard phase of the obtained cermet is cancelled, wear resistance and fracture resistance are excellent than the conventional ones, and when it is used as a cutting tool, fluctuation of tool life is a little and stable cutting can be carried out.

That is, the cermet of the present invention comprises First hard phase having a core/rim structure grains which comprise a complex carbonitride solid solution represented by (Ti_{1-x-y}LₓMo_{y})(C_{1-z}N_{z}) (provided that L represents at least one element selected from the group consisting of Zr, Hf, Nb and Ta, x represents an atomic ratio of L based on the total of Ti, M and Mo, y represents an atomic ratio of Mo based on the total of Ti, L and Mo, z represents an atomic ratio of N based on the total of C and N, and x, y and z each satisfy 0.01≦x≦0.5, 0≦y≦0.05, 0.05≦z≦0.75.) as a core, and a complex carbonitride solid solution represented by (Ti_{1-a-b-d}RₐMo_{b}W_{d})(C₁₋ₑNₑ) (wherein R represents at least one element selected from the group consisting of Zr, Hf, Nb and Ta. a represents an atomic ratio of R based on the total of Ti, R, Mo and W, b represents an atomic ratio of Mo based on the total of Ti, R, Mo and W, d represents an atomic ratio of W based on the total of Ti, R, Mo and W, e represents an atomic ratio of N based on the total of C and N, and a, b, d and e each satisfy 0.01≦a≦0.5, 0≦b≦0.05, 0.01≦d≦0.5 and 0.05≦e≦0.75.) as a rim surrounding the core, Second hard phase comprising WC, and a binder phase comprising at least one of Co and Ni as a main component, when a maximum thickness of the rim of the core/rim structure grains of First hard phase is shown by rₘₐₓ, and a minimum thickness of the rim of the core/rim structure grains of First hard phase is shown by rₘᵢₙ, then a number of the core/rim structure grains of First hard phase satisfying 0.2≦(rₘᵢₙ/rₘₐₓ)≦1 is 85% or more based on the total number of the core/rim structure grains of First hard phase.

### Effects of the Invention

The cermet and coated cermet of the present invention are excellent in wear resistance and fracture resistance, so that when they are used as a cutting tool, the effect can be obtained that tool life can be elongated. Also, when the cermet and coated cermet of the present invention are used as a cutting tool, the effect can be obtained that fluctuation of tool life is a little.

### BRIEF DESCRIPTION OF THE DRAWINGS

FIG. 1 It is a schematic view of the cross-sectional structure of First hard phase of the present invention.

### BEST MODE TO CARRY OUT THE INVENTION

The cermet of the present invention has higher hardness and toughness, and excellent in wear resistance and fracture resistance as compared with the conventional cermet comprising a carbonitride solid solution phase having a core/rim structure which comprises a core of Ti(C,N) and a rim of (Ti,W)(C,N), a WC phase and a binder phase. The cermet of the present invention has a core/rim structure wherein the core of First hard phase is a complex carbonitride solid solution shown by (Ti_{1-x-y}LₓMo_{y})(C_{1-z}N_{z}), wherein L is at least one element selected from the group consisting of Zr, Hf, Nb and Ta, x represents an atomic ratio of L based on a total of Ti, L and Mo, y represents an atomic ratio of Mo based on a total of Ti, L and Mo, z represents an atomic ratio of N based on a total of C and N, and x, y and z each satisfy 0.01≦x≦0.5, 0≦y≦0.05 and 0.05≦z≦0.75, and the rim existing around the core is a complex carbonitride solid solution shown by (Ti_{1-a-b-d}RₐMo_{b}W_{d})(C₁₋ₑNₑ), wherein R is at least one element selected from the group consisting of Zr, Hf, Nb and Ta, a represents an atomic ratio of R based on a total of Ti, R, Mo and W, b represents an atomic ratio of Mo based on the total of Ti, R, Mo and W, d represents an atomic ratio of W based on the total of Ti, R, Mo and W, e represents an atomic ratio of N based on a total of C and N, and a, b, d and e each satisfy 0.01≦a≦0.5, 0≦b≦0.05, 0.01≦d≦0.5 and 0.05≦e≦0.75. In the core of First hard phase of the cermet of the present invention, if x is less than 0.01, wear resistance and fracture resistance are lowered, while if x becomes large exceeding 0.5, it becomes an ununiform structure so that properties are not stable and when it is used as a cutting tool, tool life is fluctuated, so that x is set to 0.01≦x≦0.5. Among these, 0.05≦x≦0.3 is preferred. If y is large exceeding 0.05, thermal shock resistance is lowered so that it is made 0≦y≦0.05. Among these, when y is 0.03 or more, sinterability is improved so that 0.03≦y≦0.05 is preferred. If z is less than 0.05, wear resistance is lowered, while if z is large exceeding 0.75, sinterability is lowered so that it is made 0.05≦z≦0.75. Among these, 0.3≦z≦0.7 is preferred. In the rim of First hard phase of the cermet of the present invention, if a is less than 0.01, wear resistance and fracture resistance are lowered, while if a becomes large exceeding 0.5, it becomes an ununiform structure so that properties are not stable and when it is used as a cutting tool, tool life is fluctuated, so that a is set to 0.01≦a≦0.5. Among these, 0.05≦a≦0.3 is preferred. If b is large exceeding 0.05, thermal shock resistance is lowered so that it is made 0≦b≦0.05. Among these, if b is 0.03 or more, sinterability is improved so that 0.03≦b≦0.05 is preferred. If d is less than 0.01, wear resistance and fracture resistance are lowered, while if d is large exceeding 0.5, thermal shock resistance is lowered so that d is set to 0.01≦d≦0.5. Among these, 0.05≦d≦0.3 is preferred. If e is less than 0.05, wear resistance is lowered, while if e is large exceeding 0.75, sinterability is lowered so that e is set to 0.05≦e≦0.75. Among these, 0.3≦e≦0.7 is preferred.

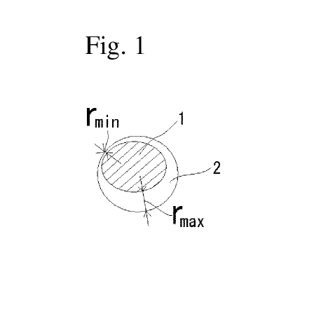

First hard phase of the present invention has the characteristics that a number of grains of the core/rim structure in which the core is surrounded by the rim is many. From the compositional image of the cross-sectional structure of the cermet enlarged to 5,000 to 10,000-fold using SEM (scanning type electron microscope), a thickness of the rim 2 is measured to the direction perpendicular to the surface of the core 1 of First hard phase of the present invention as shown in FIG. 1, and when the maximum thickness of the rim is shown by rₘₐₓ, and the minimum thickness of the rim is shown by rₘᵢₙ, then, a number of the core/rim structure grains of First hard phase satisfying 0.2≦(rₘᵢₙ/rₘₐₓ)≦1 is 85% or more based on the total number of the core/rim structure grains of First hard phase. Among these, 85 to 95% is preferred. The cermet of the present invention having such characteristics gives the effects that the properties are stable and fluctuation of tool life used as the cutting tool is a little as compared with the cermet in which a number of the core/rim structure grains of First hard phase satisfying 0.2≦(rₘᵢₙ/rₘₐₓ)≦1 is less than 85%. Incidentally, the rim with a uniform thickness is completely covered on the whole surface of the core, rₘᵢₙ=rₘₐₓ, so that rₘᵢₙ/rₘₐₓ=1, and at least a part of the core is exposed, then, rₘᵢₙ=0 μm, whereby (rₘᵢₙ.rₘₐₓ)=0.

WC which is Second hard phase of the present invention has the effects of heightening thermal conductivity and toughness of the cermet, and improving fracture resistance and thermal shock resistance.

The binder phase of the present invention has the function of heightening the strength of the cermet by firmly bonding the hard phases to each other. The binder phase mainly comprising at least one of Co and Ni of the present invention means a phase comprising at least one of Co and Ni, or a phase in which at least one selected from Ti, Zr, Hf, V, Nb, Ta, Cr, Mo and W is dissolved in at least one of Co and Ni in a total amount of less than 40% by weight. Among these, the binder phase comprising Co as a main component is more preferred since plastic deformation resistance is excellent. Incidentally, for the purpose of improvement in dissolution of the hard phase components into the binder phase or characteristics of the binder phase, it is preferred to dissolve less than 40% by weight of at least one selected from the group consisting of Ti, Zr, Hf, V, Nb, Ta, Cr, Mo and W in a total amount into at least one of Co and Ni as the binder phase.

In the cross-sectional structure of the cermet of the present invention, it is preferred that First hard phase is 35 to 85 area % based on the whole cross-sectional structure of the cermet, Second hard phase is 5 to 45 area % based on the whole cross-sectional structure of the cermet, the binder phase is 10 to 30 area % based on the whole cross-sectional structure of the cermet, and the total thereof is 100 area %. The reason is as follows. In the cross-sectional structure of the cermet of the present invention, if First hard phase is less than 35 area % based on the whole cross-sectional structure of the cermet, wear resistance tends to be lowered, while if First hard phase of the present invention becomes much exceeding 85 area % based on the whole cross-sectional structure of the cermet, an amount of the binder phase is a little, and fracture resistance tends to be lowered, so that First hard phase is preferably 35 to 85 area %, and among these, 50 to 82 area % is more preferred. If Second hard phase of the present invention is less than 5 area % based on the whole cross-sectional structure of the cermet, thermal shock resistance tends to be lowered, while if Second hard phase of the present invention becomes much exceeding 45 area % based on the whole cross-sectional structure of the cermet, wear resistance tends to be lowered, so that Second hard phase is preferably 5 to 45 area %, and among these, 5 to 40 area % is more preferred. If the binder phase of the present invention is less than 10 area % based on the whole cross-sectional structure of the cermet, fracture resistance tends to be lowered, while if the binder phase of the present invention becomes much exceeding 30 area % based on the whole cross-sectional structure of the cermet, wear resistance tends to be lowered, so that the binder phase is preferably 10 to 30 area %, and among these, 10 to 20 area % is more preferred.

It is preferred that an average grain size of First hard phase in the cross-sectional structure of the cermet of the present invention is 0.2 to 4 μm, and an average grain size of Second hard phase of the same is 0.1 to 3 μm. The reason is as follows. If the average grain size of First hard phase in the cross-sectional structure of the cermet of the present invention is less than 0.2 μm, fracture resistance is lowered, while if the average grain size of First hard phase becomes large exceeding 4 μm, wear resistance is lowered so that the average grain size of First hard phase is preferably 0.2 to 4 μm. If the average grain size of Second hard phase is less than 0.1 μm, fracture resistance is lowered, while if the average grain size of Second hard phase becomes large exceeding 3 μm, wear resistance is lowered, so that the average grain size of Second hard phase is preferably 0.1 to 3 μm. The average grain size of First hard phase or Second hard phase can be obtained from a photograph of the compositional image in which the cross-sectional structure of the cermet is photographed by SEM with 5,000 to 10,000-fold by using Fullman's equation (Formula 1).

dm=(4/π)×(NL/NS) (Formula 1)

(in Formula 1, dm represents an average grain size of First hard phase or Second hard phase, π represents a circular constant, NL represents a number of First hard phase or Second hard phase per a unit length hit by an optional straight line on the cross-sectional structure, and NS represents a number of First hard phase or Second hard phase contained in an optional unit area.).

A coated cermet in which a hard film such as an oxide, carbide, nitride and carbonitride of Ti, Zr, Hf, V, Nb, Ta, Cr, Mo, W, Al and/or Si, and mutual solid solutions thereof, diamond and diamond-like-carbon (DLC) is formed on the surface of the cermet of the present invention by the PVD method or the CVD method is excellent in wear resistance. The hard film of the present invention may be specifically mentioned TiN, TiC, TiCN, TiAlN, TiSiN, AlCrN, Al₂O₃, diamond, diamond-like-carbon (DLC), etc. If the total film thickness of the hard film is 0.1 μm or more, wear resistance is improved, and if it becomes thick exceeding 30 μm, fracture resistance tends to be lowered so that it is preferably 0.1 to 30 μm.

The cermet of the present invention can be obtained by the process for preparing the cermet comprising, for example,

(A) the step of preparing a mixture in which powders comprising 35 to 85% by volume of a complex carbonitride solid solution powder which comprises (Ti_{1--x-y}LₓMo_{y})(C_{1-z}N_{z}) (wherein L, x, y and z have the same meanings as defined above), 5 to 45% by volume of WC powder, 10 to 30% by volume of at least one of Co powder and Ni powder, and the total of these powders being 100% by volume, had been mixed and pulverized,
(B) the step of raising the temperature of the mixture to First heating temperature of 1200 to 1300° C. in a non-oxidative atmosphere,
(C) the step of raising the temperature of the mixture from First heating temperature of 1200 to 1300° C. to Second heating temperature of 1400 to 1580° C. in a nitrogen atmosphere at a pressure of 30 Ton or higher at a temperature raising rate of 1 to 10° C./min,
(D) the step of sintering the mixture by maintaining it at Second heating temperature of 1400 to 1580° C. in a nitrogen atmosphere at a pressure of 30 Torr or higher for 50 to 120 minutes, and
(E) the step of cooling the mixture finished from the step (D) to normal temperature.

Specific preparation process of the cermet of the present invention may be mentioned, for example, the following method. First, carbonitride solid solution powder which is (Ti_{1-x-y}LₓMo_{y})(C_{1-z}N_{z}) (wherein L, x, y and z have the same meanings as defined above), WC powder having an average particle size of 0.2 to 4.5 μm, and at least one of Co powder and Ni powder each having an average particle size of 0.2 to 4.5 μm are prepared. Incidentally, if the average particle size of the complex carbonitride solid solution powder of (Ti_{1-x-y}LₓMo_{y})(C_{1-z}N_{z}) is less than 0.2 μm, fracture resistance is lowered, while if it becomes large exceeding 4.5 μm, wear resistance is lowered so that the average particle size of the complex carbonitride solid solution powder of (Ti_{1-x-y}LₓMo_{y})(C_{1-z}N_{z}) is preferably 0.2 to 4.5 μm. If the average particle size of the WC powder is less than 0.2 μm, fracture resistance is lowered, while if it becomes large exceeding 4.5 μm, wear resistance is lowered so that the average particle size of the WC powder is preferably 0.2 to 4.5 μm. If the average particle size of at least one of the Co powder and Ni powder is less than 0.2 μm, moldability is lowered, while if it becomes large exceeding 4.5 μm, sinterability is lowered so that the average particle size of at least one of the Co powder and Ni powder is preferably 0.2 to 4.5 μm.

Each of the prepared starting powder is weighed so that they are predetermined formulation composition, mixed and pulverized by a wet ball mill or an attritor, and evaporating the solvent to dry the mixture. To the obtained mixture was added a wax for molding such as paraffin, etc. to carry out molding to a predetermined shape. The molding method may be mentioned a press molding, extrusion molding, injection molding, etc. The molded mixture is placed in a sintering furnace, the temperature is raised to 350 to 450° C. in vacuum to remove the wax, and then, the temperature is raised to First heating temperature of 1200 to 1300° C. in vacuum or a nitrogen atmosphere. At this time, by raising the temperature of the mixture in a non-oxidative atmosphere such as in vacuum, nitrogen atmosphere, inert gas atmosphere, hydrogen atmosphere, etc., oxidation of the mixture can be prevented. Further, the mixture is sintered by raising the temperature from First heating temperature of 1200 to 1300° C. to Second heating temperature of 1400 to 1580° C. in a nitrogen atmosphere at a pressure of 30 Torr or higher with a temperature raising rate of 1 to 10° C./min, and by maintaining the same at Second heating temperature in a nitrogen atmosphere at a pressure of 30 Torr or higher for 50 to 120 min. The pressure of the nitrogen atmosphere is preferably 30 Torr or higher, but if it becomes high exceeding 100 Torr, sinterability of the cermet is lowered so that it is preferably 30 to 300 Torr, and among these, it is further preferably 50 to 150 Torr. At around 1300° C., Co and Ni are melted to become a liquid phase, part of (Ti_{1-x-y}LₓMo_{y})(C_{1-z}N_{z}) powder and WC powder is melted in the liquid phase, and Ti, L, Mo, W, C and/or N melted in the liquid phase precipitates on the grains of (Ti_{1-x-y}LₓMo_{y})(C_{1-z}N_{z}) as a rim of the complex carbonitride solid solution whereby core/rim structure grains of First hard phase comprising a core of (Ti_{1-x-y}LₓMo_{y})(C_{1-z}N_{z}) and a rim of (Ti_{1-a-b-d}RₐMo_{b}W_{d})(C₁₋ₑNₑ) are formed. Also, on the WC, no rim of the complex carbonitride solid solution is formed since the crystal structure, etc., are different from each other, and it becomes Second hard phase comprising WC. After sintering, the mixture is cooled to normal temperature to obtain a cermet of the present invention.

The coated cermet of the present invention can be obtained by coating a hard film on the surface of the cermet of the present invention by the PVD method or the CVD method.

### EXAMPLES

In the following, the present invention is explained in more detail by referring to Examples, but the present invention is not limited by these.

### Example 1

As starting materials for the cermets, (Ti_{0.9}Zr_{0.1})(C_{0.5}N_{0.5}) powder having an average particle size of 1.5 μm, (Ti_{0.9}Hf_{0.1})(C_{0.5}N_{0.5}) powder having an average particle size of 1.5 μm, (Ti_{0.9}Ta_{0.1})(C_{0.5}N_{0.5}) powder having an average particle size of 1.5 μm, (Ti_{0.9}Nb_{0.1})(C_{0.5}N_{0.5}) powder having an average particle size of 1.5 μm, (Ti_{0.8}Nb_{0.2})(C_{0.55}N_{0.45}) powder having an average particle size of 1.5 μm, (Ti_{0.9}Cr_{0.1})(C_{00.5}N_{0.5}) powder having an average particle size of 1.5 μm, (Ti_{0.8}V_{0.1})(C_{0.5}N_{0.5}) powder having an average particle size of 1.5 μm, (Ti_{0.85}Nb_{0.1}Mo_{0.05})(C_{0.5}N_{0.5}) powder having an average particle size of 1.5 μm, Ti(C_{0.5}N_{0.5}) powder having an average particle size of 1.3 μm, TiN powder having an average particle size of 1.4 μm, ZrC powder having an average particle size of 2.0 μm, TaC powder having an average particle size of 2.1 μm, NbC powder having an average particle size of 1.1 μm, WC powder having an average particle size of 1.3 μm, Mo₂C powder having an average particle size of 1.3 μm, Co powder having an average particle size of 1.3 μm and Ni powder having an average particle size of 1.3 μm were prepared. By using these powders, they were weighed to formulation compositions shown in Table 1.

TABLE 1

| Sample No. | Formulation composition (% by volume) |
|---|---|
| Present product 1 | 69%(Ti_{0.9}Zr_{0.1})(C_{0.5}N_{0.5})—21%WC—10%Co |
| Present product 2 | 69%(Ti_{0.9}Hf_{0.1})(C_{0.5}N_{0.5})—21%WC—10%Co |
| Present product 3 | 69%(Ti_{0.9}Ta_{0.1})(C_{0.5}N_{0.5})—21%WC—10%Co |
| Present product 4 | 69%(Ti_{0.9}Nb_{0.1})(C_{0.5}N_{0.5})—21%WC—10%Co |
| Present product 5 | 80%(Ti_{0.9}Nb_{0.1})(C_{0.5}N_{0.5})—10%WC—10%Co |
| Present product 6 | 69%(Ti_{0.8}Nb_{0.2})(C_{0.55}N_{0.45})—21%WC—10%Co |
| Present product 7 | 65%(Ti_{0.9}Nb_{0.1})(C_{0.5}N_{0.5})—21%WC—14%Co |
| Present product 8 | 56%(Ti_{0.9}Nb_{0.1})(C_{0.5}N_{0.5})—30%WC—7%Co—7%Ni |
| Present product 9 | 56%(Ti_{0.85}Nb_{0.1}Mo_{0.05})(C_{0.5}N_{0.5})—30%WC—7%Co—7%Ni |
| Comparative product 1 | 69%(Ti_{0.9}Cr_{0.1})(C_{0.5}N_{0.5})—21%WC—10%Co |
| Comparative product 2 | 69%(Ti_{0.9}V_{0.1})(C_{0.5}N_{0.5})—21%WC—10%Co |
| Comparative product 3 | 69%Ti(Co_{0.5}N_{0.5})—21%WC—10%Co |
| Comparative product 4 | 51.8%Ti(Co_{0.5}N_{0.5})—8.3%TiN—8.9%ZrC—21%WC—10%Co |
| Comparative product 5 | 52.6%Ti(C_{0.5}N_{0.5})—8.5%TiN—7.9%NbC—21%WC—10%Co |
| Comparative product 6 | 68.6%Ti(C_{0.5}N_{0.5})—8.5%TiN—7.9%NbC—5%WC—10%Co |
| Comparative product 7 | 47.2%Ti(C_{0.5}N_{0.5})—2.4%TiN—6.4%NbC—30%WC—7%Co—7%Ni |
| Comparative product 8 | 41.9%Ti(C_{0.5}N_{0.5})—4.9%TiN—6.4%NbC—2.8%Mo₂C—30%WC—5%Co—5%Ni |

The weighed mixed powder was mixed and pulverized by a wet ball mill, then, the solvent was evaporated to dry the mixture. To the dried mixture was added paraffin, and the resulting mixture was subjected to press molding to a size where the size after sintering became ISO Standard TNMG160408 Cutting insert shape. The press molded mixture was placed in a sintering furnace, a temperature of which was raised to 350 to 450° C. in vacuum to evaporate the paraffin, and further raised to First heating temperature of 1280° C. in vacuum. Further, the temperature of the mixture was raised from First heating temperature of 1280° C. to Second heating temperature of 1530° C. in a nitrogen atmosphere at a pressure of 100 Torr with a temperature raising rate of 1.7° C./min, and sintered by maintaining at Second heating temperature of 1530° C. in a nitrogen atmosphere at a pressure of 100 Torr for 50 minutes. After sintering, the product was cooled to normal temperature to obtain cermets of Present products 1 to 8 and Comparative products 1 to 7.

The cross-sectional structures of the obtained cermets were observed by a scanning type electron microscope, and the compositions of First hard phase, Second hard phase and the binder phase were measured by an EDS attached with a scanning type electron microscope. Also, from the photograph in which the cross-sectional structure of the cermet was photographed with a 10,000-fold, average grain sizes of First hard phase and Second hard phase were measured by using the Fullmann's equation. These results were shown in Table 2. Also, from the photograph in which the cross-sectional structure of the cermet was photographed with a 10,000-fold, an area ratio S₁ of First hard phase, an area ratio S₂ of Second hard phase, and an area ratio S₃ of the binder phase were measured. These values were shown in Table 3.

TABLE 2

| | First hard phase | | Second hard phase | | |
|---|---|---|---|---|---|
| | | Average | | Average | Binder phase |
| | | grain size | | grain size | Composition |
| Sample No. | Composition | (μm) | Composition | (μm) | (% by weight) |
| Present | Core/rim structure comprising | 1.0 | WC | 0.9 | 73.1%Co— |
| product 1 | (Ti_{0.9}Zr_{0.1})(C_{0.5}N_{0.5}) of core and | | | | 1.3%Ti—0.6%Zr— |
| | (Ti_{0.7}W_{0.2}Zr_{0.1})(C_{0.7}N_{0.3}) of rim | | | | 25%W |
| Present | Core/rim structure comprising | 1.0 | WC | 0.9 | 73.1%Co— |
| product 2 | (Ti_{0.9}Hf_{0.1})(C_{0.5}N_{0.5}) of core and | | | | 1.3%Ti— |
| | (Ti_{0.7}W_{0.2}Hf_{0.1})(C_{0.7}N_{0.3}) of rim | | | | 0.5%Nb—25%W |
| Present | Core/rim structure comprising | 0.8 | WC | 0.9 | 73.2%Co— |
| product 3 | (Ti_{0.9}Ta_{0.1})(C_{0.5}N_{0.5}) of core and | | | | 1.3%Ti— |
| | (Ti_{0.7}W_{0.2}Ta_{0.1})(C_{0.7}N_{0.3}) of rim | | | | 0.5%Ta—25%W |
| Present | Core/rim structure comprising | 0.8 | WC | 0.9 | 73.1%Co— |
| product 4 | (Ti_{0.9}Nb_{0.1})(C_{0.5}N_{0.5}) of core and | | | | 1.3%Ti— |
| | (Ti_{0.7}W_{0.2}Nb_{0.1})(C_{0.7}N_{0.3}) of rim | | | | 0.6%Nb—25%W |
| Present | Core/rim structure comprising | 0.8 | WC | 0.9 | 73.1%Co— |
| product 5 | (Ti_{0.9}Nb_{0.1})(C_{0.5}N_{0.5}) of core and | | | | 1.3%Ti— |
| | (Ti_{0.7}W_{0.2}Nb_{0.1})(C_{0.7}N_{0.3}) of rim | | | | 0.6%Nb—25%W |
| Present | Core/rim structure comprising | 0.8 | WC | 0.9 | 73.1%Co— |
| product 6 | (Ti_{0.8}Nb_{0.2})(C_{0.55}N_{0.45}) of core | | | | 1.3%Ti— |
| | and (Ti_{0.7}W_{0.2}Nb_{0.1})(C_{0.7}N_{0.3}) of rim | | | | 0.6%Nb—25%W |
| Present | Core/rim structure comprising | 0.8 | WC | 0.9 | 73.1%Co— |
| product 7 | (Ti_{0.9}Nb_{0.1})(C_{0.5}N_{0.5}) of core and | | | | 1.3%Ti— |
| | (Ti_{0.7}W_{0.2}Nb_{0.1})(C_{0.7}N_{0.3}) of rim | | | | 0.6%Nb—25%W |
| Present | Core/rim structure comprising | 0.8 | WC | 0.9 | 36.6%Co— |
| product 8 | (Ti_{0.9}Nb_{0.1})(C_{0.5}N_{0.5}) of core and | | | | 36.6%Ni— |
| | (Ti_{0.7}W_{0.2}Nb_{0.1})(C_{0.7}N_{0.3}) of rim | | | | 1.3%Ti— |
| | | | | | 0.6%Nb— |
| | | | | | 24.9%W |
| Present | Core/rim structure comprising | 0.8 | WC | 0.9 | 35%Co—35%Ni— |
| product 9 | (Ti_{0.85}Nb_{0.1}Mo_{0.05})(C_{0.5}N_{0.5}) of | | | | 1.3%Ti— |
| | core and | | | | 0.6%Nb— |
| | (Ti_{0.66}W_{0.2}Nb_{0.1}MO_{0.04})(C_{0.7}N_{0.3}) of rim | | | | 5%Mo—23.1%W |
| Comparative | Core/rim structure comprising | 1.0 | WC | 0.8 | 65.7%Co— |
| product 1 | (Ti_{0.9}Cr_{0.1})(C_{0.5}N_{0.5}) of core and | | | | 1.3%Ti—8%Cr— |
| | (Ti_{0.7}W_{0.2}Cr_{0.1})(C_{0.7}N_{0.3}) of rim | | | | 25%W |
| Comparative | Core/rim structure comprising | 1.0 | WC | 0.8 | 73.1%Co— |
| product 2 | (Ti_{0.9}V_{0.1})(C_{0.5}N_{0.5}) of core and | | | | 1.3%Ti— |
| | (Ti_{0.7}W_{0.2}V_{0.1})(C_{0.7}N_{0.3}) of rim | | | | 0.6%V—25%W |
| Comparative | Core/rim structure comprising | 0.8 | WC | 0.9 | 73.1%Co— |
| product 3 | Ti(C_{0.5}N_{0.5}) of core and | | | | 1.3%Ti— |
| | (Ti_{0.8}W_{0.2})(C_{0.7}N_{0.3}) of rim | | | | 0.6%Nb— |
| | | | | | 25%W |
| Comparative | Ti(C_{0.5}N_{0.5}) having no core/rim | 1.0 | WC | 0.9 | 73.1%Co— |
| product 4 | structure and | | | | 1.3%Ti— |
| | (Ti_{0.7}W_{0.2}Zr_{0.1})(C_{0.6}N_{0.4}) having | | | | 0.6%Zr—25%W |
| | no core/rim structure | | | | |
| Comparative | Ti(C_{0.5}N_{0.5}) having no core/rim | 0.7 | WC | 0.9 | 73.1%Co— |
| product 5 | structure and | | | | 1.3%Ti— |
| | (Ti_{0.6}W_{0.2}Nb_{0.1})(Co_{0.7}No_{0.3}) having | | | | 0.6%Nb— |
| | no core/rim structure | | | | 25%W |
| Comparative | Core/rim structure comprising | 0.8 | None | — | 76.1%Co— |
| product 6 | Ti(C_{0.5}N_{0.5}) of core and | | | | 1.3%Ti— |
| | (Ti_{0.6}W_{0.2}Nb_{0.2})(C_{0.7}N_{0.3}) of rim | | | | 0.6%Nb— |
| | | | | | 22%W |
| Comparative | Ti(C_{0.5}N_{0.5}) having no core/rim | 0.7 | WC | 0.9 | 36.6%Co— |
| product 7 | structure and | | | | 36.6%Ni— |
| | (Ti_{0.6}W_{0.2}Nb_{0.2})(C_{0.7}N_{0.3}) having | | | | 1.3%Ti— |
| | no core/rim structure | | | | 0.6%Nb— |
| | | | | | 24.9%W |
| Comparative | Ti(C_{0.5}N_{0.5}) having no core/rim | 0.8 | WC | 0.9 | 35%Co— |
| product 8 | structure and | | | | 35%Ni— |
| | (Ti_{0.66}W_{0.2}Nb_{0.1}Mo_{0.04})(C_{0.7}N_{0.3}) | | | | 1.3%Ti— |
| | having no core/rim structure | | | | 0.6%Nb— |
| | | | | | 5%Mo— |
| | | | | | 23.1%W |

TABLE 3

| | First hard | Second hard | |
|---|---|---|---|
| | phase | phase | Binder phase |
| Sample No. | S₁ (area %) | S₂ (area %) | S₃ (area %) |
| Present product 1 | 72 | 18 | 10 |
| Present product 2 | 71 | 19 | 10 |
| Present product 3 | 74 | 16 | 10 |
| Present product 4 | 73 | 17 | 10 |
| Present product 5 | 82 | 8 | 10 |
| Present product 6 | 72 | 18 | 10 |
| Present product 7 | 67 | 19 | 14 |
| Present product 8 | 67 | 19 | 14 |
| Present product 9 | 57 | 29 | 14 |
| Comparative product 1 | 74 | 16 | 10 |
| Comparative product 2 | 71 | 19 | 10 |
| Comparative product 3 | 71 | 19 | 10 |
| Comparative product 4 | 75 | 15 | 10 |
| Comparative product 5 | 76 | 14 | 10 |
| Comparative product 6 | 90 | 0 | 10 |
| Comparative product 7 | 58 | 28 | 14 |
| Comparative product 8 | 58 | 28 | 14 |

Also, with regard to First hard phase, the maximum thickness of the rim was made rₘₐₓ, and the minimum thickness of the same was made rₘᵢₙ, a number of First hard phase grains with the core/rim structure satisfying 0.2≦(rₘᵢₙ/rₘₐₓ)≦1 was counted, and a value A(%) in which the above number was divided by the total number of First hard phase grains was calculated. The results were shown in Table 4. When the value is higher, it means that the portion of the core of the core/rim structure grains not covered by the rim is not present and an existing ratio of the grains in which the rim is uniformly present at the surface of the core is much.

TABLE 4

| | Existing ratio A (%) of core/rim |
|---|---|
| | structure grains satisfying |
| Sample No. | 0.2 ≦ (rₘᵢₙ/rₘₐₓ) ≦ 1 |
| Present product 1 | 85 |
| Present product 2 | 85 |
| Present product 3 | 88 |
| Present product 4 | 87 |
| Present product 5 | 89 |
| Present product 6 | 90 |
| Present product 7 | 87 |
| Present product 8 | 87 |
| Present product 9 | 88 |
| Comparative product 1 | 65 |
| Comparative product 2 | 80 |
| Comparative product 3 | 75 |
| Comparative product 4 | 0 |
| Comparative product 5 | 0 |
| Comparative product 6 | 27 |
| Comparative product 7 | 0 |
| Comparative product 8 | 0 |

To the obtained cermets were applied grinding and honing, and they were processed to cutting inserts each with a shape of ISO Standard TNMG160408. Cutting tests 1 and 2 were carried out by using these products under the following Cutting conditions.

### [Cutting Test 1]

Fracture resistance evaluation test (Turning)
Shape of Cutting insert: TNMG160408,
Work piece material: S45C (Shape: substantially cylindrical to which four grooves were provided to the cylinder),
Cutting speed: 150 m/min,

### Depth of cut: 0.5 mm,

Feed rate: 0.2 mm/rev,
Cooling method: Dry cutting,
3 times repeated,
Judgment criteria of tool life: A number of impacts until the cutting tool had fractured is defined to be a tool life.

The results of Cutting test 1 were shown in Table 5. In the present invention, the case where fluctuation in a number of impacts until fractured is a little, then, it is judged as having high stability in tool life, and the case where fluctuation in the number of impacts until fractured is a large, then, it is judged as having low stability in tool life. Thus, the stability of tool life was evaluated with regard to the difference dI (times) (dI=Imax−Imin) between the maximum value Imax (times) of the number of impacts until fractured and the minimum value Imin (times) of the number of impacts until fractured, dI=0 to 2000 times was shown as \textcircled{∘}, dI=2001 to 5000 times was ◯, dI=5001 to 10000 times was Δ, and dI=10001 times or more was ×. At this time, order of the stability of tool life is [Excellent] \textcircled{∘}>◯>Δ>×[poor].

TABLE 5

| | Cutting test 1 | | | | | |
|---|---|---|---|---|---|---|
| | (Number of impacts/time) | | | | | |
| | 1^{st} | 2^{nd} | 3^{rd} | | | Stability |
| Sample No. | time | time | time | Average | dI | of tool life |
| Present | 22398 | 25178 | 23785 | 23787 | 2780 | ◯ |
| product 1 | | | | | | |
| Present | 25065 | 25088 | 22398 | 24184 | 2690 | ◯ |
| product 2 | | | | | | |
| Present | 29300 | 31026 | 29782 | 30036 | 1726 | ⊚ |
| product 3 | | | | | | |
| Present | 28123 | 29020 | 27892 | 28345 | 1128 | ⊚ |
| product 4 | | | | | | |
| Present | 27521 | 24980 | 26021 | 26174 | 2541 | ◯ |
| product 5 | | | | | | |
| Present | 31846 | 30056 | 29872 | 30591 | 1974 | ⊚ |
| product 6 | | | | | | |
| Present | 27087 | 26452 | 25003 | 26181 | 2084 | ◯ |
| product 7 | | | | | | |
| Present | 29745 | 30962 | 29089 | 29932 | 1873 | ⊚ |
| product 8 | | | | | | |
| Present | 31124 | 32846 | 32820 | 32263 | 1722 | ⊚ |
| product 9 | | | | | | |
| Comparative | 12290 | 6342 | 25065 | 14566 | 18723 | X |
| product 1 | | | | | | |
| Comparative | 10232 | 9342 | 15450 | 11675 | 6108 | Δ |
| product 2 | | | | | | |
| Comparative | 24983 | 17023 | 23021 | 21676 | 7960 | Δ |
| product 3 | | | | | | |
| Comparative | 25012 | 17209 | 19807 | 20676 | 7803 | Δ |
| product 4 | | | | | | |
| Comparative | 25172 | 21209 | 19980 | 22120 | 5192 | Δ |
| product 5 | | | | | | |
| Comparative | 21033 | 14832 | 26021 | 20629 | 11189 | X |
| product 6 | | | | | | |
| Comparative | 21203 | 25265 | 28807 | 25092 | 7604 | Δ |
| product 7 | | | | | | |
| Comparative | 27320 | 18456 | 20234 | 22003 | 8864 | Δ |
| product 8 | | | | | | |

From the results shown in Table 5, it can be understood that Present products are excellent in fracture resistance and are possible to carry out stable cutting as compared with those of Comparative products.

### [Cutting Test 2]

Wear resistance evaluation test (Turning)
Shape of Cutting insert: TNMG160408,
Work piece material: S53C (Shape: cylindrical),
Cutting speed: 200 m/min,

### Depth of cut: 1.0 mm,

Feed rate: 0.2 mm/rev,
Cooling method: Wet cutting,
Judgment criteria of tool life: When the tool is fractured, or a maximum flank wear V_{Bmax} became 0.3 mm or more, then, it is defined to be a tool life.

The results of Cutting test 2 were shown in Table 6.

TABLE 6

Cutting test 2

| | Judgment criteria of | |
|---|---|---|
| Sample No. | tool life | Cutting length |
| Present product 1 | Wear | 4.6 km |
| Present product 2 | Wear | 4.6 km |
| Present product 3 | Wear | 5.8 km |
| Present product 4 | Wear | 5.4 km |
| Present product 5 | Wear | 5.6 km |
| Present product 6 | Wear | 5.8 km |
| Present product 7 | Wear | 4.8 km |
| Present product 8 | Wear | 5.4 km |
| Present product 9 | Wear | 6.0 km |
| Comparative product 1 | Fracture | 2.8 km |
| Comparative product 2 | Fracture | 1.8 km |
| Comparative product 3 | Wear | 3.6 km |
| Comparative product 4 | Wear | 3.8 km |
| Comparative product 5 | Wear | 4.0 km |
| Comparative product 6 | Wear | 3.3 km |
| Comparative product 7 | Wear | 4.0 km |
| Comparative product 8 | Wear | 3.8 km |

From the results shown in Table 6, it can be understood that Present products are excellent in wear resistance and have longer tool lives as compared with those of Comparative products.

Grinding and honing were applied to the cermets of Present products 4, 5 and 9 and the cermets of Comparative products 5, 6 and 8 before processing, and they were processed to cutting inserts each having a shape of ISO Standard TNMG160408. As shown in Table 5, a TiAlN film with an average film thickness of 2.5 μm was provided on the surface of the cutting insert by the PVD method to prepare, Present products 10, 11 and 12, and Comparative products 9, 10 and 11. By using these samples, Cutting test 3 was carried out.

TABLE 7

| Sample No. | Hard film | Substrate |
|---|---|---|
| Present product 10 | 2.5 μm TiAlN | Cermet of Present |
| | | product 4 |
| Present product 11 | 2.5 μm TiAlN | Cermet of Present |
| | | product 5 |
| Present product 12 | 2.5 μm TiAlN | Cermet of Present |
| | | product 9 |
| Comparative product 9 | 2.5 μm TiAlN | Cermet of Comparative |
| | | product 5 |
| Comparative product 10 | 2.5 μm TiAlN | Cermet of Comparative |
| | | product 6 |
| Comparative product 11 | 2.5 μm TiAlN | Cermet of Comparative |
| | | product 8 |

### [Cutting Test 3]

Wear resistance evaluation test (Turning)
Shape of Cutting insert: TNMG160408,
Work piece material: S53C (Shape: cylindrical),
Cutting speed: 200 m/min,

### Depth of cut: 1.0 mm,

Feed rate: 0.2 mm/rev,
Cooling method: Dry cutting,
Judgment criteria of tool life: When the tool was fractured, or the maximum flank wear V_{Bmax} of the tool became 0.3 mm or more, then, it is defined to be a tool life.

The results of Cutting test 3 were shown in Table 8.

TABLE 8

| | Judgment criteria of | |
|---|---|---|
| Sample No. | tool life | Cutting length |
| Present product 10 | Wear | 6.0 km |
| Present product 11 | Wear | 6.1 km |
| Present product 12 | Wear | 6.7 km |
| Comparative product 9 | Wear | 4.1 km |
| Comparative product 10 | Wear | 3.4 km |
| Comparative product 11 | Wear | 4.1 km |

From the results shown in Table 8, it can be understood that Present products 10 to 12 are excellent in wear resistance and has a longer lifetime as compared with those of Comparative products 9 to 11.

### Example 2

To the cermets of Present products 1 to 9 and cermets of Comparative product 1 to 8 before processing of Example 1 were applied grinding and honing, and machined to cutting inserts with a shape of ISO Standard SDEN1203AETN. Cutting test under Cutting condition 4 was carried out by using these.

Wear resistance evaluation test (milling, face milling)
Shape of Cutting insert: SDEN1203AETN,
Work piece material: SCM440 (Shape: 76×150×200 mm to which 6 holes with φ 30 were provided),
Cutting speed: 150 m/min,

### Depth of cut: 2.0 mm,

Feed rate: 0.25 mm/t,
Cooling method: Dry cutting,

### Width of cut: 105 mm,

Cutting length per 1 pass: 200 mm
Cutter diameter: φ 160 mm (1 sheet blade)
3 times repeated,
Judgment criteria of tool life: Cutting length until the tool fractured is defined to be a life time.

The results of Cutting test 4 were shown in Table 9. In the present invention, the case where fluctuation in cutting length until fractured is a little, then, it is judged as having high stability in tool life, and the case where fluctuation in the cutting length until fractured is a large, then, it is judged as having low stability in tool life. Thus, the stability of tool life was evaluated with regard to the difference dl (m) (dl=lmax−lmin) between the maximum value lmax (m) of the cutting length until fractured and the minimum value lmin (m) of the cutting length until fractured, dl=0 to 0.5 m is shown as \textcircled{∘}, d1=0.6 to 1.0 m is ◯, dl=1.1 to 2.0 m is Δ and dl=2.1 m or more is x . At this time, order of the stability of tool life is [Excellent] \textcircled{∘}>◯>Δ>× [poor].

TABLE 9

| | Cutting test 4 | | | | | |
|---|---|---|---|---|---|---|
| | (Cutting length/m until fracture) | | | | | |
| | 1^{st} | 2^{nd} | 3^{rd} | | | Stability |
| Sample No. | time | time | time | Average | dl | of tool life |
| Present | 2.9 | 3.1 | 3.3 | 3.1 | 0.4 | ⊚ |
| product 1 | | | | | | |
| Present | 3.8 | 3.6 | 3.2 | 3.5 | 0.6 | ◯ |
| product 2 | | | | | | |
| Present | 4.2 | 4.5 | 3.9 | 4.2 | 0.6 | ◯ |
| product 3 | | | | | | |
| Present | 4.2 | 4.3 | 3.9 | 4.1 | 0.4 | ⊚ |
| product 4 | | | | | | |
| Present | 3.8 | 3.6 | 4.2 | 3.9 | 0.6 | ◯ |
| product 5 | | | | | | |
| Present | 4.2 | 4.0 | 3.9 | 4.0 | 0.3 | ⊚ |
| product 6 | | | | | | |
| Present | 5.8 | 5.2 | 4.9 | 5.3 | 0.9 | ◯ |
| product 7 | | | | | | |
| Present | 4.7 | 5.6 | 4.9 | 5.1 | 0.9 | ◯ |
| product 8 | | | | | | |
| Present | 6.7 | 7.2 | 6.8 | 6.9 | 0.5 | ⊚ |
| product 9 | | | | | | |
| Comparative | 0.7 | 2.8 | 2.2 | 1.9 | 2.1 | X |
| product 1 | | | | | | |
| Comparative | 0.2 | 1.3 | 0.4 | 0.6 | 1.1 | Δ |
| product 2 | | | | | | |
| Comparative | 2.6 | 2.7 | 0.8 | 2.0 | 1.9 | Δ |
| product 3 | | | | | | |
| Comparative | 4.0 | 4.2 | 0.2 | 2.8 | 4.0 | X |
| product 4 | | | | | | |
| Comparative | 1.7 | 4.0 | 0.7 | 2.1 | 3.3 | X |
| product 5 | | | | | | |
| Comparative | 1.4 | 0.3 | 3.1 | 1.6 | 2.8 | X |
| product 6 | | | | | | |
| Comparative | 0.9 | 3.4 | 2.8 | 2.4 | 2.5 | X |
| product 7 | | | | | | |
| Comparative | 3.4 | 4.1 | 1.2 | 2.9 | 2.9 | X |
| product 8 | | | | | | |

From the results shown in Table 9, it can be understood that Present products are excellent in fracture resistance and possible to carry out stable cutting as compared with those of Comparative products.

### EXPLANATION OF REFERENCE NUMERALS

1 Core
2 Rim

1. A cermet which comprises a first hard phase comprising a complex carbonitride solid solution containing Ti, a second hard phase comprising WC, and a binder phase comprising at least one of Co and Ni as a main component, wherein the first hard phase has a core/rim structure comprising:
a core of a complex carbonitride solid solution represented by (Ti_{1-x-y}LₓMo_{y})(C_{1-z}N_{z}), wherein:
L represents at least one element selected from the group consisting of Zr, Hf, Nb and Ta,
x represents an atomic ratio of L based on a total of Ti, L and Mo,
y represents an atomic ratio of Mo based on the total of Ti, L and Mo,
z represents an atomic ratio of N based on a total of C and N, and
x, y and z satisfy 0.01≦x≦0.5, 0≦y≦0.05 and 0.05≦z≦0.75, and
a rim of a complex carbonitride solid solution represented by (Ti_{1-a-b-d}RₐMo_{b}W_{d})(C₁₋ₑNₑ), wherein
R represents at least one element selected from the group consisting of Zr, Hf, Nb and Ta,
a represents an atomic ratio of R based on a total of Ti, R, Mo and W,
b represents an atomic ratio of Mo based on the total of Ti, R, Mo and W,
d represents an atomic ratio of W based on the total of Ti, R, Mo and W,
e represents an atomic ratio of N based on a total of C and N, and
a, b, d and e satisfy 0.01≦a≦0.5, 0≦b≦0.05, 0.01≦d≦0.5 and 0.05≦e≦0.75, and
when a maximum thickness of the rim of the core/rim structure grains of the first hard phase is given by rₘₐₓ, and a minimum thickness of the rim of the core/rim structure grains of the first hard phase is given by rₘᵢₙ, a number of the core/rim structure grains of the first hard phase satisfying 0.2≦(rₘᵢₙ/rₘₐₓ)≦1 is 85% or more, based on the total number of the core/rim structure grains of the first hard phase.

2. The cermet according to claim 1, wherein x satisfies 0.05≦x≦0.3.

3. The cermet according to claim 1, wherein y satisfies 0.03≦y≦0.05.

4. The cermet according to claim 1, wherein z satisfies 0.3≦z≦0.7.

5. The cermet according to claim 1, wherein a satisfies 0.05≦a≦0.3.

6. The cermet according to claim 1, wherein b satisfies 0.03≦b≦0.05.

7. The cermet according to claim 1, wherein d satisfies 0.05≦d≦0.3.

8. The cermet according to claim 1, wherein e satisfies 0.3≦e≦0.7.

9. The cermet according to claim 1, wherein a number of core/rim structure grains of the first hard phase satisfying 0.2≦(rₘᵢₙ/rₘₐₓ)≦1 is 85 to 90%, based on the total number of the core/rim structure grains of the first hard phase.

10. The cermet according to claim 1, wherein:
the first hard phase in a cross-sectional structure of the cermet is 35 to 85 area %,
the second hard phase of the same is 5 to 45 area %,
the binder phase of the same is 10 to 30 area %, and
the total thereof is 100 area %.

11. The cermet according to claim 1, wherein:
the first hard phase in a cross-sectional structure of the cermet is 50 to 82 area %,
the second hard phase of the same is 5 to 40 area %,
the binder phase of the same is 10 to 20 area %, and
the total thereof is 100 area %.

12. A coated cermet comprising the cermet according to claim 1 having a surface thereof which is coated by a hard film.

13. The cermet according to claim 1, wherein x, y and z satisfy 0.05≦x≦0.3, 0.03≦y≦0.05 and 0.3≦z≦0.7.

14. The cermet according to claim 13, wherein a number of core/rim structure grains of the first hard phase satisfying 0.2≦(rₘᵢₙ/rₘₐₓ)≦1 is 85 to 90%, based on the total number of the core/rim structure grains of the first hard phase.

15. The cermet according to claim 13, wherein:
the first hard phase in a cross-sectional structure of the cermet is 35 to 85 area %,
the second hard phase of the same is 5 to 45 area %,
the binder phase of the same is 10 to 30 area %, and
the total thereof is 100 area %.

16. A coated cermet comprising the cermet according to claim 13 having a surface thereof coated by a hard film.

17. The cermet according to claim 1, wherein a, b, d and e satisfy 0.05≦a≦0.3, 0.03≦b≦0.05, 0.05≦d≦0.3 and 0.3≦e≦0.7.

18. The cermet according to claim 17, wherein a number of core/rim structure grains of the first hard phase satisfying 0.2≦(rₘᵢₙ/rₘₐₓ)≦1 is 85 to 90%, based on the total number of the core/rim structure grains of the first hard phase.

19. The cermet according to claim 17, wherein:
the first hard phase in a cross-sectional structure of the cermet is 35 to 85 area %,
the second hard phase of the same is 5 to 45 area %,
the binder phase of the same is 10 to 30 area %, and
the total thereof is 100 area %.

20. A coated cermet comprising the cermet according to claim 17 having a surface thereof coated by a hard film.
